(19) United States
(12) Patent Application Publication
(10) Pub. No.: US 2018/0063130 A1
(43) Pub. Date: Mar. 1, 2018

(54) TERMINAL CONTROL METHOD AND DEVICE

(71) Applicant: GUANGDONG OPPO MOBILE TELECOMMUNICATIONS CORP. LTD ., Dongguan (CN)

(72) Inventors: Haiping ZHANG, Dongguan (CN); Le YANG, Dongguan (CN)

(73) Assignee: GUANGDONG OPPO MOBILE TELECOMMUNICATIONS CORP. LTD ., Dongguan (CN)

(21) Appl. No.: 15/784,279

(22) Filed: Oct. 16, 2017

Related U.S. Application Data
(63) Continuation of application No. PCT/CN2016/091536, filed on Jul. 25, 2016.

(30) Foreign Application Priority Data
Oct. 28, 2015 (CN) 201510719752.8

(51) Int. Cl. H04L 29/06

(52) U.S. Cl. CPC H04L 63/0861; H04L 67/025; H04L 63/10

(57) ABSTRACT

A terminal control method includes acquiring eyeball information of a user upon receiving an operation request of the user; sending an application request to a control terminal, the application request carrying the eyeball information, for the control terminal to perform identity authentication according to the eyeball information; receiving permission information returned by the control terminal after the identity authentication is passed; and executing the operation request on the basis of the permission information. Also disclosed are a further terminal control method and corresponding devices.

### CROSS REFERENCE TO RELATED APPLICATIONS

This application is a continuation application of International Application No. PCT/CN2016/091536, filed Jul. 25, 2016, entitled “TERMINAL CONTROL METHOD, DEVICE AND SYSTEM”, which claims the priority from the Chinese patent application No. 201510719752.8, filed Oct. 28, 2015, entitled “TERMINAL CONTROL METHOD, DEVICE AND SYSTEM”, the disclosures for which are hereby incorporated herein in their entireties by reference.

### FIELD

The present disclosure relates generally to the technical filed of communication technologies, and more particularly, to a terminal control method and device.

### BACKGROUND

With the development of communication technology, terminals, such as smart phones, tablet PCs or personal computers, have become more and more popular, and gradually become an integral part of people's lives. The existence of the terminal not only enriches people's lives, but also brings a lot of convenience. At the same time, however, it also brings some drawbacks, such as personal information security problems, affection to children by bad information, or network addiction problems, etc. Therefore, there is the need for appropriate control of the terminal.

Generally, the use of the terminal is controlled by setting corresponding permission in the terminal. For example, in order to prevent strangers from peeking at the album in the terminal, the user can set a password for the album in the terminal; only those passing the authentication can view the album. As another example, in order to prevent children from using the terminal too much, the parent can set the time of use of the terminal, such that when the use of time exceeds the set value, the terminal will be turned off, etc.

### SUMMARY

Embodiments of the present disclosure provide a control method and device for a terminal which can improve the security and flexibility of terminal control.

The embodiments of the present disclosure provide a terminal control method, including:

acquiring eyeball information of a user upon receiving an operation request of the user;

sending an application request to a control terminal, the application request carrying the eyeball information, for the control terminal to perform identity authentication according to the eyeball information;

receiving permission information returned by the control terminal after the identity authentication is passed; and

executing the operation request on the basis of the permission information.

The embodiments of the present disclosure provide another terminal control method, including:

receiving an application request from a controlled terminal, the application request carrying eyeball information;

acquiring a preset eyeball information sample according to the application request;

performing identity authentication according to the eyeball information and the eyeball information sample;

if the identity authentication is passed, acquire corresponding permission information based on the eyeball information and return the permission information to the controlled terminal; and

if the identity authentication fails, reject the application request.

Furthermore, the embodiments of the present disclosure further provide a controlled device, including:

an acquiring unit, configured to acquire eyeball information of a user upon receiving an operation request of the user;

a sending unit, configured to send an application request to a control terminal, the application request carrying the eyeball information, for the control terminal to perform identity authentication according to the eyeball information;

a receiving unit, configured to receive permission information returned by the control terminal after the identity authentication is passed; and

an executing unit, configured to execute the operation request on the basis of the permission information.

Other features of the technology will be apparent from consideration of the information contained in the following detailed description.

### BRIEF DESCRIPTION OF THE DRAWINGS

In order to better illustrate the technical schemes of the present disclosure, a brief description of the accompanying drawings used herein is given below. Obviously, the drawings listed below are only embodiments and a person skilled in the art should be noted that, other drawings can also be obtained on the basis of these exemplary drawings without creative activity.

FIG. 1a is a schematic view of a scenario of a terminal control system provided by an embodiment of the present disclosure.

FIG. 1b is a flow chart of a terminal control method provided by an embodiment of the present disclosure.

FIG. 2 is another flow chart of a terminal control method provided by an embodiment of the present disclosure.

FIG. 3 is a further flow chart of a terminal control method provided by an embodiment of the present disclosure.

FIG. 4a is a schematic diagram of a controlled device provided by an embodiment of the present disclosure.

FIG. 4b is another schematic view of the controlled device provided by the embodiment of the present disclosure.

FIG. 5a is a schematic structural view of a control device provided by an embodiment of the present disclosure.

FIG. 5b is another schematic view of the control device provided by the embodiment of the present disclosure.

FIG. 6 is a schematic diagram of the components of a terminal provided by an embodiment of the present invention.

### DETAILED DESCRIPTION

Technical schemes of the present disclosure will be described clearly and completely in conjunction with accompanying drawings. The implementations illustrated below are merely part rather than all of the present disclosure. Any other implementation obtained by one skilled in the art based on the implementations described herein without creativity work should fall into the protective scope of the present disclosure.

The embodiments of the present disclosure provide a terminal control method, device and system.

The terminal control system can include any one of the control devices and controlled devices as provided by the embodiments of the embodiments of the present disclosure, and both the control device and the controlled device can be integrated into the terminal.

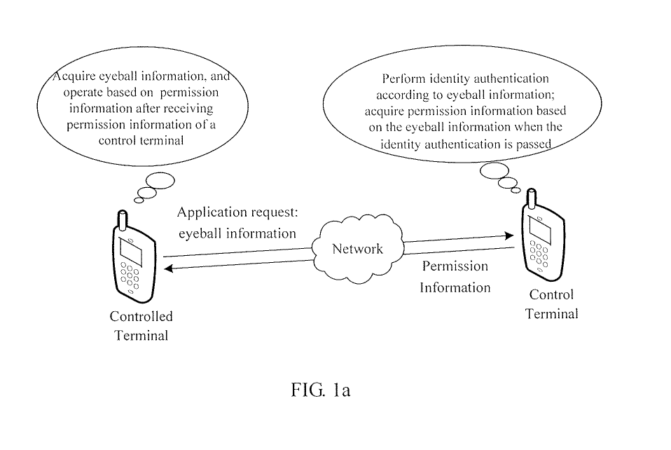

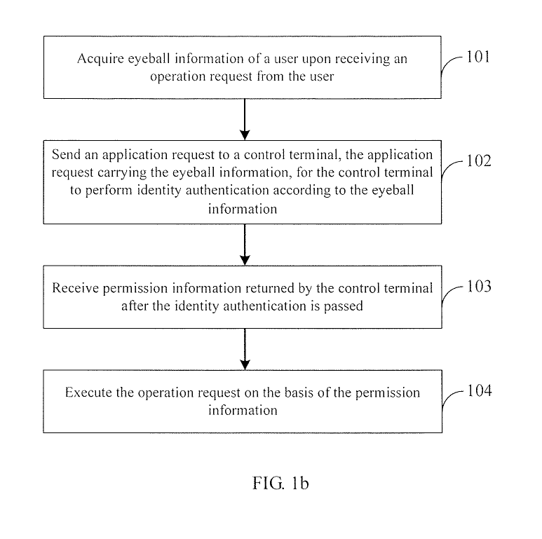

Referring to FIG. 1a, for the convenience of description, a terminal into which a control device is integrated is referred to as a control terminal, and a terminal into which a controlled device is integrated is referred to as a controlled terminal. When the user needs to operate on the controlled terminal, the controlled terminal can obtain eye information of the user, and then send an application request to the control terminal, carrying the eyeball information in the application request, so that the control terminal can perform identity authentication according to the eyeball information. For example, the control terminal may obtain a preset eyeball information sample according to the application request, and then perform identity authentication according to the eyeball information and the eyeball information sample. If the authentication is passed, the control terminal may acquire corresponding permission information according to the eyeball information, and return the permission information to the controlled terminal, etc., so that the controlled terminal can execute the corresponding operation on the basis of the permission information; in this way the purpose of the flexible control of the controlled terminal by the control terminal can be realized.

The present disclosure will be described in detail. It is to be noted that the numbers of the following embodiments are not to limit the preferred sequence of the embodiments.

### Embodiment I

This embodiment is described from the perspective of the controlled device that may be integrated into a terminal. The terminals can be smart phones, tablet PCs, laptops or personal computers (PC) and other devices. In order to facilitate the description, in an embodiment of the present disclosure, the terminal in which the controlled device is integrated is referred to as the controlled terminal.

A terminal control method may include: acquiring eyeball information of a user upon receiving an operation request of the user; sending an application request to a control terminal, the application request carrying the eyeball information, for the control terminal to perform identity authentication according to the eyeball information; receiving permission information returned by the control terminal after the identity authentication is passed; and executing the operation request on the basis of the permission information.

As shown in FIG. 1b, a terminal control method is provided.

At 101, eyeball information of a user is acquired by a controlled terminal upon that an operation request of the user is received.

The operation request may be a request for staring a terminal, running a terminal application in the terminal or using some of the functionalities in the terminal or the terminal application, etc. There may be a variety of triggers for the operation request. For example, the user may click on or slide the icon of the terminal application to be opened, click on or slide a preset trigger key, or trigger the operation at the time the terminal is started, etc. The specific trigger mode can be set according to the needs of the actual application.

The eyeball information may include, in addition to iris information and/or scleral information, information such as eyeball statuses and/or trajectories, including eyes closing, blink, eyeball sliding, eyeball rotation, and the like.

At 102, an application request is sent to a control terminal, the application request carrying the eyeball information, for the control terminal to perform identity authentication according to the eyeball information.

For example, the control terminal may obtain a preset eyeball information sample according to the application request, and then perform identity authentication according to the eyeball information sample and the eyeball information. For example, whether the eyeball information matches the eyeball information sample and, if matched, indicate that the authentication is passed; otherwise, indicate that the authentication fails, etc.

The eyeball information sample may be sent by the controlled terminal to the control terminal in addition to being directly stored in the control terminal by the user, that is, the terminal control method may also include, before sending an application request to the control terminal, acquiring eyeball information sample of the user, and sending the eyeball information sample to the control terminal for the control terminal to store the eyeball information sample.

In addition to a pre-specified control terminal, a plurality of terminals may be bound in advance as candidate control terminals; then, when sending an application request, the user selects a control terminal from among the plurality of terminals. That is, the terminal control method may further include, before sending an application request to a control terminal, acquiring and displaying a list of binding terminals, receiving a selection instruction triggered by the user according to the list of binding terminals, and determining a corresponding binding terminal as the control terminal from the list of binding terminals according to the selection instruction.

It is also possible to establish a binding relationship with the other terminals before acquiring and displaying the list of binding terminals, that is, establishing a binding relationship between the controlled terminal and the other terminals (candidate control terminals), and create a list of binding terminals according to the binding relationship.

Optionally, in order to improve the flexibility, users may be categorized with different control methods for different categories of users. For example, adult users may not need permission control to the controlled terminal they are using; and for children, it is necessary to perform permission control. For example, it is also possible to allow a group of users to use the controlled terminal after they apply for permission, and the rest of the users are not allowed to use the terminal at all, etc. That is, the terminal control method may further include, before sending an application request to a control terminal, determining whether the user belongs to a preset user category according to the eyeball information, and if the user belongs to a preset user category, send the application request to the control terminal, otherwise, execute the operation request or reject the operation request according to a preset policy.

There may be a plurality of ways of determining whether the user belongs to a preset user category. For example, in at least one alternative embodiment, the method may include acquiring a set of eyeball information samples corresponding to the preset user category, determining whether there is, in the set of eyeball information samples, an eyeball information sample matching the eyeball information, if there is, determine that the user belongs to the preset user category, otherwise, determine that the user does not belong to the preset user category.

The preset policy can be set according to the needs of the actual application. For example, it is possible to set that the users other than the preset user category have operation permission, or the users other than the preset user category have no operation permission, or a portion of the user have operation permission, etc. If the user has operation permission, then the operation request can be executed at this time; otherwise, the operation request will be rejected.

At 103, permission information returned by the control terminal is received after the identity authentication is passed.

The permission information may indicate that the user is allowed to use the controlled terminal in full or within a certain range of permission, and may be realized in the form of acknowledgment messages (that is, the permission range is indicated in the application request by the controlled terminal, and then confirmed by the control terminal) or indication messages (that is, direct indication of the permission range).

At 104, the operation request is executed on the basis of the permission information. For example, the method may include determining usage permission of the user according to the permission information, and executing the operation request within a range of the usage permission.

In at least one embodiment, if the operation request is for starting the terminal, an activation state of the terminal may be started and maintained within a usage time range indicated by the usage permission; alternatively, if the operation request is for accessing a terminal application, the user may be allowed to access a corresponding function of the terminal application within a permission range indicated by the usage permission, etc.

From the above, the controlled terminal of the embodiment may acquire eyeball information of the user upon receiving an operation request of the user; then, the controlled terminal may send an application request to a control terminal, the application request carrying the eyeball information, for the control terminal to perform identity authentication according to the eyeball information; after that, the controlled terminal may receive permission information returned by the control terminal after the identity authentication is passed, and execute the operation request on the basis of the permission information. By this scheme, it is possible to acquire by one terminal, i.e., the control terminal, the eyeball information of the user of another terminal, i.e., the controlled terminal, and control the operation permission of the controlled terminal based on the eyeball information. Thus, compared to that the identity authentication can only be performed by the controlled terminal itself, it is possible to reduce the possibility that the authentication information is stolen, and greatly improve the security. In addition, the controlled terminal can initiate the application request to the control terminal at any time, and the control terminal can allocate corresponding operation permission flexibly according to the eye information of the current user of the controlled terminal; thus, the flexibility of the implementation can be improved.

### Embodiment II

This embodiment is described from the perspective of the control device that may be integrated into a terminal. The terminals can be smart phones, tablet PCs, laptops or personal computers (PC) and other devices. In order to facilitate the description, in an embodiment of the present disclosure, the terminal in which the control device is integrated is referred to as the control terminal.

A terminal control method, including: receiving an application request from a controlled terminal, the application request carrying eyeball information, acquiring a preset eyeball information sample according to the application request; performing identity authentication according to the eyeball information and the eyeball information sample; if the identity authentication is passed, acquire corresponding permission information based on the eyeball information and returned to the controlled terminal; and if the identity authentication fails, reject the application request.

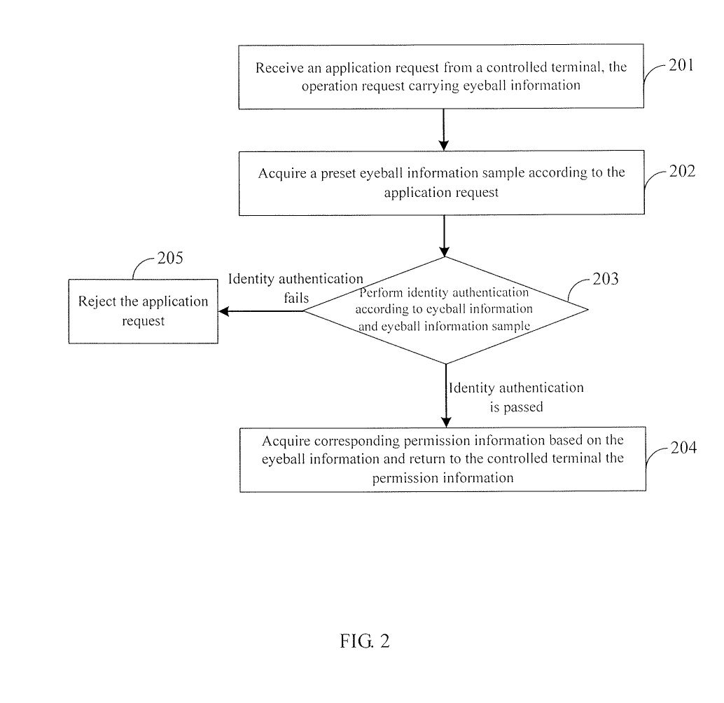

As shown in FIG. 2, a terminal control method is provided.

At 201, an application request from a controlled terminal is received by a control terminal, the application request carrying eyeball information.

The eyeball information may include, in addition to iris information and/or scleral information, information such as eyeball statuses and/or trajectories, including eyes closing, blink, eyeball sliding, eyeball rotation, and the like.

Optionally, the relationship between the controlled terminal and the control terminal may be preset, or may be established by the controlled terminal and the control terminal themselves. That is, the terminal control method may further include, before receiving an application request from a controlled terminal, establishing a binding relationship with the controlled terminal.

At 202, a preset eyeball information sample is acquired by the control terminal according to the application request.

The eyeball information sample may be sent by the controlled terminal to the control terminal in addition to being directly stored in the control terminal by the user, that is, the terminal control method may also include, before acquiring a preset eyeball information sample according to the application request, receiving input eyeball information sample of the user, or receiving eyeball information sample of the user sent by the controlled terminal.

At 203, identity authentication is performed according to the eyeball information and the eyeball information sample; and if the identity authentication is passed, 204 is performed, and if the identity authentication fails, 205 is performed.

At 204, if the identity authentication is passed, corresponding permission information is acquired based on the eyeball information, and the permission information is returned to the controlled terminal.

For example, it is possible to directly query a preset permission table according to the eyeball information and acquire corresponding permission information from the permission table. Optionally, it is also possible to determine the user attribute based on the eyeball information, and acquire the corresponding permission information according to the user attribute, etc.

The permission table contains the mapping relation of the eyeball information and the permission information.

At 205, if the identity authentication fails, the application request is rejected.

Optionally, it is possible to return to the user rejection reason.

From the above, the control terminal of the embodiment may receive an application request from a controlled terminal, perform identity authentication according to the eyeball information carried in the application request, allocate corresponding operation permission if the identity authentication is passed, such that the controlled terminal can perform control on the basis of the permission. By this scheme, it is possible to acquire by one terminal, i.e., the control terminal, the eyeball information of the user of another terminal, i.e., the controlled terminal, and control the operation permission of the controlled terminal based on the eyeball information. Thus, compared to that the identity authentication can only be performed by the controlled terminal itself, it is possible to reduce the possibility that the authentication information is stolen, and greatly improve the security. In addition, the controlled terminal can initiate the application request to the control terminal at any time, and the control terminal can allocate corresponding operation permission flexibly according to the eye information of the current user of the controlled terminal; thus, the flexibility of the implementation can be improved.

### Embodiment III

More examples will be described based on the methods of Embodiments I and II.

In an embodiment, both the control device and the controlled device are integrated into terminals, with the controlled terminal labeled as Terminal A, and the control terminal as Terminal B.

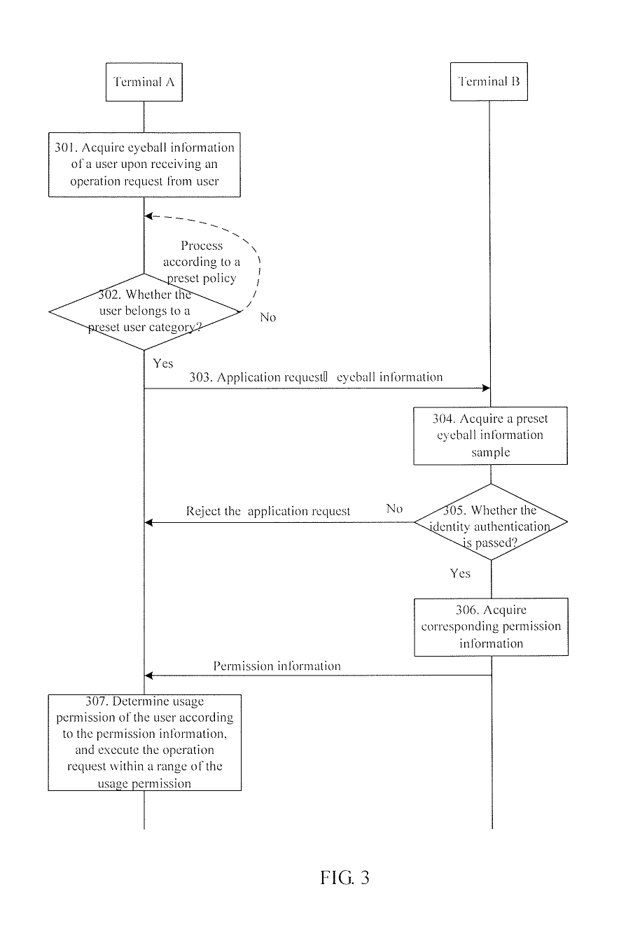

As shown in FIG. 3, a terminal control method is provided.

At 301, eyeball information of a user is acquired by Terminal A upon receiving an operation request of the user. For example, eyeball information of the user may be acquired using a camera, etc.

The operation request may be a request for staring a terminal, running a terminal application in the terminal or using some of the functionalities in the terminal or the terminal application, etc. There may be a variety of triggers for the operation request. For example, the user may click on or slide the icon of the terminal application to be opened, click on or slide a preset trigger key, or trigger the operation at the time the terminal is started, etc. The specific trigger mode can be set according to the needs of the actual application.

The eyeball information may include, in addition to iris information and/or scleral information, information such as eyeball statuses and/or trajectories, including eyes closing, blink, eyeball sliding, eyeball rotation, and the like.

Take the control of a terminal for a child by a parent for example. If the terminal for the child is Terminal A, it is possible to acquire by Terminal A eyeball information of the child at the time Terminal A is turned on by the child.

In at least one alternative embodiment, obtaining of the user's eyeball information is not to be limited to the time of upon receiving an operation request of the user, of which there can be a variety of triggering conditions. For example, according to preset instructions, Terminal A can spontaneously collect at preset intervals the eyeball statuses and/or trajectories of the child during the usage of Terminal A. For example, it is possible to set a terminal of 5 min, 10 min or 30 min each time for obtaining the eyeball information.

At 302, it is determined by Terminal A whether the user belongs to a preset user category according to the eyeball information; and if the user belongs to a preset user category, 303 is performed, otherwise, it is performed according to a preset policy, e.g., the operation request is executed or rejected.

There may be a plurality of ways of determining whether the user belongs to a preset user category. In at least one alternative embodiment, the method may include: acquiring a set of eyeball information samples corresponding to the preset user category, determining whether there is, in the set of eyeball information samples, an eyeball information sample matching the eyeball information, if there is, determine that the user belongs to the preset user category, otherwise, determine that the user does not belong to the preset user category.

Take the control of a terminal for a child by a parent for example. The eyeball information of the user group to be controlled, for example, of the Child K, is collected and stored in the set of eyeball information samples. If it is determined that the current user belongs to the user group to be controlled, for example, the current user is Child K, then 303 may be performed; otherwise, if it is determined that the current user does not belong to the user group to be controlled, for example, the current user is an adult, then perform according to a preset policy to execute the operation request or reject the operation request.

The preset policy can be set according to the needs of the actual application. For example, it is possible to set that the users other than the preset user category have operation permission, or the users other than the preset user category have no operation permission, or a portion of the user have operation permission, etc. If the user has operation permission, then the operation request can be executed at this time; otherwise, the operation request will be rejected.

At 303, an application request is sent by Terminal A to Terminal B, the application request carrying the eyeball information.

For example, Terminal A may send the application request to Terminal B via Wireless Fidelity (WIFI), Internet, or data network.

Take the control of a terminal for a child by a parent for example. Terminal B can be a terminal for a parent, e.g., terminal used by father or mother of the child, etc.

At 304, a preset eyeball information sample is acquired by Terminal B according to the application request upon receiving the application request.

The eyeball information sample may be sent by the controlled terminal to the control terminal in addition to being directly stored in the control terminal by the user, that is, Terminal B may be configured to receive input eyeball information sample of the user, or receive eyeball information sample of the user sent by Terminal A.

Still take the control of a terminal for a child by a parent for example. Terminal B can acquire preset eyeball information sample of the child according to the application request; the eyeball information sample can be input in advance to Terminal B, or can be collected by Terminal A or other devices and sent to Terminal B.

At 305, identity authentication is performed by Terminal B according to the eyeball information and the eyeball information sample; if the identity authentication is passed, 306 is performed, and if the identity authentication fails, the application request is rejected. Optionally, it is possible to return to the user rejection reason.

For example, it is possible to determine whether the eyeball information matches the eyeball information sample; and if matched, it is indicated that the authentication is passed and 306 is performed; otherwise, it is indicated that the authentication fails and the application request is rejected, etc.

In at least one alternative embodiment, Terminal B can also perform the other types of authentication according to the eyeball information and the eyeball information sample. For example, authentication is performed with regard to the usage continuity of the child. During the usage Terminal A, the eyeball statuses and/or trajectories may be changed due to eye fatigue after a long time. To prevent the child from abusing the electronic devices, it is possible for Terminal B to compare eyeball information obtained at preset time intervals to the eyeball information sample so as to perform authentication in real time.

At 306, corresponding permission information is acquired by Terminal B according to the eyeball information, and is returned to Terminal A.

For example, it is possible to directly query a preset permission table according to the eyeball information and acquire corresponding permission information from the permission table. Optionally, it is also possible to determine the user attribute based on the eyeball information, and acquire the corresponding permission information according to the user attribute, etc.

The permission information may indicate that the user is allowed to use Terminal A in full or within a certain range of permission, and may be realized in the form of acknowledgment messages or indication messages. By acknowledgment messages, the permission range may be indicated in the application request by Terminal A, and then confirmed by Terminal B, and indication messages provide direct indication of the permission range.

At 307, usage permission of the user is determined by Terminal A according to the permission information, and the operation request is executed within a range of the usage permission. In at least one alternative embodiment, if the operation request is for starting the terminal, an activation state of the terminal is started and maintained within a usage time range indicated by the usage permission, i.e., allowing the user to use the terminal with some time periods; and if the operation request is for accessing a terminal application, for example, game applications, etc., then the user is allowed to access a corresponding function of the terminal application within a permission range indicated by the usage permission. For example, the user is allowed to access only game functions suitable for children in the game application, etc.

In at least one alternative embodiment, Terminal A can control the usage time and functional permission of the child in real time according to the permission information obtained at preset time intervals from Terminal B.

From the above, Terminal A of the embodiment may acquire eyeball information of the user upon receiving an operation request of the user, then send an application request to Terminal B, the application request carrying the eyeball information, for Terminal B to perform identity authentication according to the eyeball information. Terminal A may receive permission information returned by the Terminal B after the identity authentication is passed, and execute the operation request on the basis of the permission information. By this scheme, it is possible to acquire by one terminal, i.e., Terminal B, the eyeball information of the user of another terminal, i.e., Terminal A, and control the operation permission of Terminal A based on the eyeball information. Thus, compared to that the identity authentication can only be performed by the controlled terminal itself, it is possible to reduce the possibility that the authentication information is stolen, and greatly improve the security. In addition, Terminal A can initiate the application request to Terminal B at any time, and Terminal B can allocate corresponding operation permission flexibly according to the eye information of the current user of Terminal A; thus, the flexibility of the implementation can be improved.

### Embodiment IV

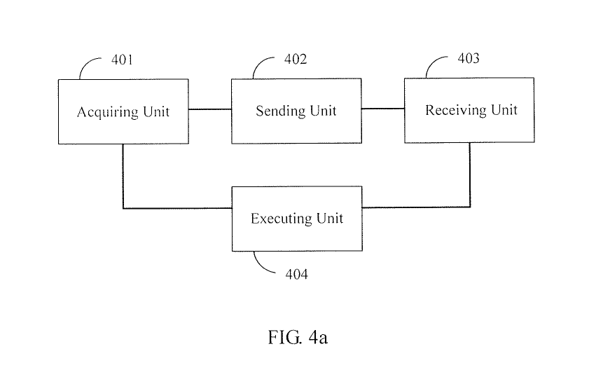

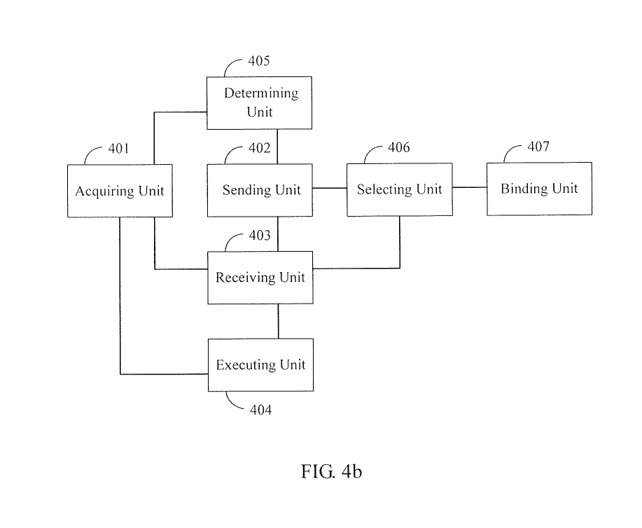

Accordingly, the embodiments of the present disclosure further provide a controlled device. As shown in FIG. 4a, the controlled device may include an acquiring unit 401, a sending unit 402, a receiving unit 403 and an executing unit 404.

The acquiring unit 401 may be configured to acquire eyeball information of a user upon receiving an operation request of the user.

The eyeball information may include, in addition to iris information and/or sclera( information, information such as eyeball statuses and/or trajectories, including eyes closing, blink, eyeball sliding, eyeball rotation, and the like.

The sending unit 402 may be configured to send an application request to a control terminal, the application request carrying the eyeball information, for the control terminal to perform identity authentication according to the eyeball information.

The receiving unit 403 may be configured to receive permission information returned by the control terminal after the identity authentication is passed.

The executing unit 404 may be configured to execute the operation request on the basis of the permission information.

For example, the executing unit 404 may be configured to determine usage permission of the user according to the permission information, and execute the operation request within a range of the usage permission.

Optionally, in order to improve the flexibility, users may be categorized with different control methods for different categorizations of users. For example, adult users may not need permission control to the controlled terminal they are using; and for children, it is necessary to perform permission control. For example, it is also possible to allow a group of users to use the controlled terminal after they apply for permission, and the rest of the users are not allowed to use the terminal at all, etc. As shown in FIG. 4b, the controlled device may further include a determining unit 405. The determining unit 405 is configured to determine whether the user belongs to a preset user category according to the eyeball information.

For example, the determining unit 405 may be configured to acquire a set of eyeball information samples corresponding to the preset user category, determine whether there is, in the set of eyeball information samples, an eyeball information sample matching the eyeball information, and if there is, determine that the user belongs to the preset user category, otherwise, determine that the user does not belong to the preset user category.

The sending unit 402 may be configured to execute an operation of sending an application request to the control terminal, when the determining unit 405 determines that the user belongs to the preset user category.

The executing unit 404 may be further configured to execute the operation request or reject the operation request according to a preset policy, when the determining unit 405 determines that the user does not belong to the preset user category.

The preset policy can be set according to the needs of the actual application. For example, it is possible to set that the users other than the preset user category have operation permission, or the users other than the preset user category have no operation permission, or a portion of the user have operation permission, etc. If the user has operation permission, then the operation request can be executed at this time; otherwise, the operation request will be rejected.

In at least one alternative embodiment, the eyeball information sample may be sent by the controlled terminal to the control terminal in addition to being directly stored in the control terminal by the user. In this alternative embodiment, the acquiring unit 401 may be further configured to acquire eyeball information sample of the user. The sending unit 402 may be further configured to send the eyeball information sample to the control terminal for the control terminal to store the eyeball information sample.

In addition to a pre-specified control terminal, in at least one alternative embodiment, a plurality of terminals may be bound in advance as candidate control terminals, and when sending an application request, the user selects a control terminal from among the plurality of terminals. As shown in FIG. 4b, the controlled device may further include a selecting unit 406. In this alternative embodiment, the acquiring unit 401 may be further configured to acquire and display a list of binding terminals. The receiving unit 403 may be further configured to receive a selection instruction triggered by the user according to the list of binding terminals. The selecting unit 406 may be further configured to determine a corresponding binding terminal as the control terminal from the list of binding terminals according to the selection instruction.

It is also possible to establish a binding relationship with the other terminals before acquiring and displaying the list of binding terminals, that is, the controlled device may also include a binding unit 407.

The binding unit 407 may be configured to establish a binding relationship with the other terminals, and create a list of binding terminals according to the binding relationship.

When implemented, the above units can be realized as independent entities, or can be in any combination as the same or a number of entities. One can refer to the above method embodiments about implementations of the respective units, which will not be described here.

The controlled device can be integrated into the terminal such as smart phones, tablet PCs, laptops or personal computers (PC) and other devices.

From the above, the acquiring unit 401 of the controlled device of the embodiment may acquire eyeball information of the user upon receiving an operation request of the user; then, the sending unit 402 may send an application request to a control terminal, the application request carrying the eyeball information, for the control terminal to perform identity authentication according to the eyeball information; after that, the receiving unit 403 may receive permission information returned by the control terminal after the identity authentication is passed, and the executing unit 404 may execute the operation request on the basis of the permission information. By this scheme, it is possible to acquire by one terminal, i.e., the control terminal, the eyeball information of the user of another terminal, i.e., the controlled terminal, and control the operation permission of the controlled terminal based on the eyeball information. Thus, compared to that the identity authentication can only be performed by the controlled terminal itself, it is possible to reduce the possibility that the authentication information is stolen, and greatly improve the security. In addition, the controlled terminal can initiate the application request to the control terminal at any time, and the control terminal can allocate corresponding operation permission flexibly according to the eye information of the current user of the controlled terminal; thus, the flexibility of the implementation can be improved.

### Embodiment V

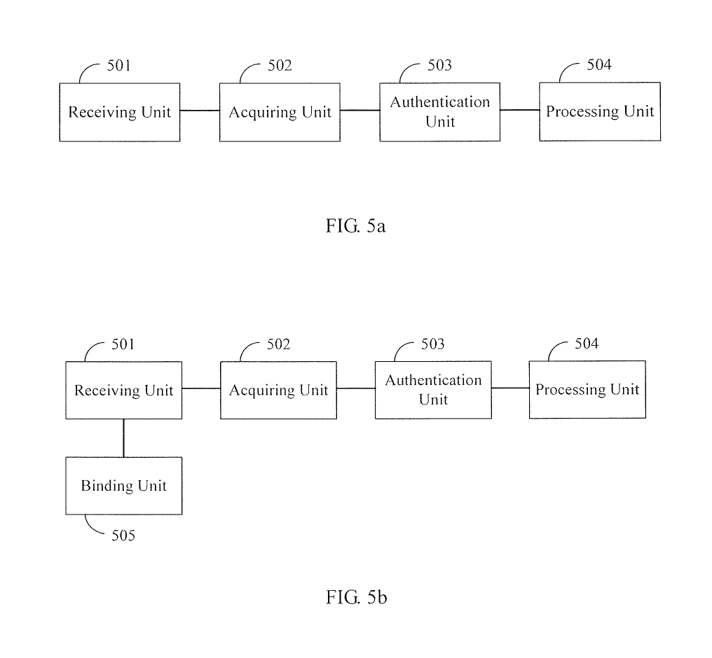

Accordingly, the embodiments of the present disclosure further provide a control device. As shown in FIG. 5a, the control device may include a receiving unit 501, an acquiring unit 502, an authentication unit 503 and a processing unit 504.

The receiving unit 501may be configured to receive an application request from a controlled terminal, the application request carrying eyeball information.

The eyeball information may include, in addition to iris information and/or scleral information, information such as eyeball statuses and/or trajectories, including eyes closing, blink, eyeball sliding, eyeball rotation, and the like.

The acquiring unit 502 may be configured to acquire a preset eyeball information sample according to the application request.

The authentication unit 503 may be configured to perform identity authentication according to the eyeball information and the eyeball information sample.

For example, the authentication unit 503 may be configured to determine whether the eyeball information matches the eyeball information sample and, if matched, indicate that the authentication is passed; otherwise, indicate that the authentication fails, etc.

The processing unit 504 may be configured to acquire corresponding permission information based on the eyeball information and return the permission information to the controlled terminal if the authentication unit 503 determines that the identity authentication is passed, and reject the application request if the identity authentication fails.

For example, the processing unit 504 may be configured to determine the user attribute based on the eyeball information, and acquire corresponding permission information according to the user attribute, if the authentication unit 503 determines that the identity authentication is passed.

Optionally, the processing unit 504 may be configured to directly query a preset permission table according to the eyeball information and acquire corresponding permission information from the permission table, if the authentication unit 503 determines that the identity authentication is passed. The permission table contains the mapping relation of the eyeball information and the permission information.

The eyeball information sample may be sent by the controlled terminal to the control terminal in addition to being directly stored in the control terminal by the user. In at least one alternative embodiment, the receiving unit 501 may be further configured to receive input eyeball information sample of the user, or receive eyeball information sample of the user sent by the controlled terminal.

Optionally, the relationship between the controlled terminal and the control terminal may be preset, or may be established by the controlled terminal and the control terminal themselves. As shown in FIG. 5b, the control terminal may further include a binding unit 505. The binding unit 505 may be configured to establish a binding relationship with the controlled terminal.

When implemented, the above units can be realized as independent entities, or can be in any combination as the same or a number of entities. One can refer to the above method embodiments about implementations of the respective units, which will not be described here.

The control device can be integrated into the terminal such as smart phones, tablet PCs, laptops or personal computers (PC) and other devices.

From the above, the receiving unit 501 of the control device of the embodiment may receive an application request from a controlled terminal, then the authentication unit 503 may perform identity authentication according to the eyeball information carried in the application request, and the processing unit 504 may allocate corresponding operation permission if the identity authentication is passed, such that the controlled terminal can perform operation on the basis of the permission. By this scheme, it is possible to acquire by one terminal, i.e., the control terminal, the eyeball information of the user of another terminal, i.e., the controlled terminal, and control the operation permission of the controlled terminal based on the eyeball information. Thus, compared to that the identity authentication can only be performed by the controlled terminal itself, it is possible to reduce the possibility that the authentication information is stolen, and greatly improve the security. In addition, the controlled terminal can initiate the application request to the control terminal at any time, and the control terminal can allocate corresponding operation permission flexibly according to the eye information of the current user of the controlled terminal; thus, the flexibility of the implementation can be improved.

### Embodiment VI

In addition, the embodiments of the present disclosure further provide a terminal control system, which may include any one of the controlled devices and any one of the control devices as provided by the embodiments of the present disclosure. Embodiment IV can be referred to as for the controlled device, and Embodiment V can be referred to as for the control device, and both the controlled device and the control device can be integrated into the terminals. For the convenience of description, a terminal into which a control device is integrated is referred to as a control terminal, and a terminal into which a controlled device is integrated is referred to as a controlled terminal. In at least one alternative embodiment, a terminal control system includes a controlled device and a control device.

The controlled terminal is configured to acquire eyeball information of a user upon receiving an operation request of the user, send an application request to a control terminal, the application request carrying the eyeball information, receive permission information returned by the control terminal after identity authentication is passed, and execute the operation request on the basis of the permission information.

The control terminal is configured to receive an application request from the controlled terminal, the application request carrying eyeball information, acquire a preset eyeball information sample according to the application request, perform identity authentication according to the eyeball information and the eyeball information sample, and if the identity authentication is passed, acquire corresponding permission information based on the eyeball information and return the permission information to the controlled terminal, and if the identity authentication fails, reject the application request.

Optionally, the controlled terminal may be further configured to determine whether the user belongs to a preset user category according to the eyeball information, and if the user belongs to a preset user category, then execute operation of sending the application request to the control terminal, otherwise, execute the operation request or reject the operation request according to a preset policy.

One can refer to the above embodiments about implementations of the respective devices, which will not be described here.

Since the terminal control system may include any one of the controlled devices and any one of the control devices as provided by the embodiments of the present disclosure, it can also achieve the beneficial effects of any one of the controlled devices and any one of the control devices; one can refer to the above embodiments for the details which will not be described here.

### Embodiment VII

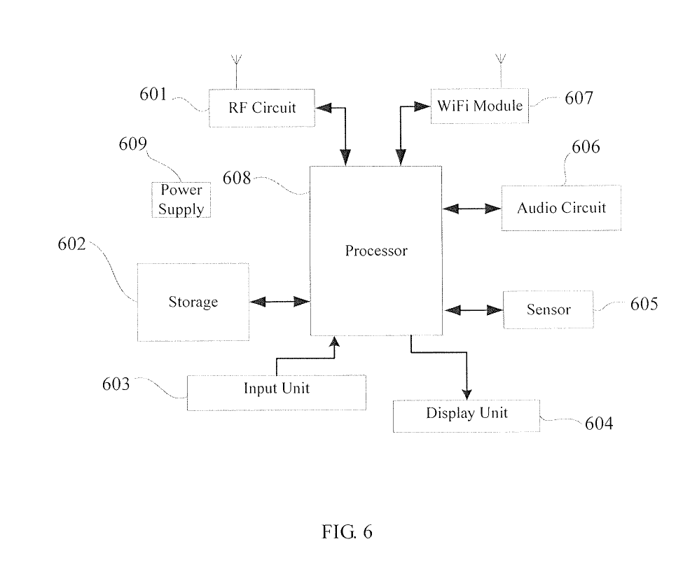

Accordingly, the embodiments of the present disclosure further provide a terminal. As shown in FIG. 6, the terminal may include: a Radio frequency (RF) circuit 601, a storage 602 including one or more computer readable storage mediums, an input unit 603, a display unit 604, a sensor 605, an audio circuit 606, a Wireless Fidelity (WiFi) module 607, a processor 608 including one or more processing cores, and a power source 609, etc. It should be understood by those skilled in the art that, a structure of the terminal shown in FIG. 6 is not intended to limit the terminal, which may include more or less components than as shown in FIG. 7, and some components may be combined, or the components may be in another arrangement.

The RF circuit 601 may be configured to receive and send signals during receiving and sending messages or making a phone call, and in particular, deliver downlink information of a base station to one or more processors 608 to process and send uplink data to the base station. The RF circuit 601 usually includes, but not limited to, an antenna, at least one amplifier, a tuner, one or more oscillators, a Subscriber Identity Module (SIM) card, a transceiver, a coupler, a Low Noise Amplifier (LNA), a duplexer, etc. In addition, the RF circuit 601 may communicate with a network or other devices through wireless communication. The wireless communication may be performed according to any communication standard or protocol, including but not limited to: Global System of Mobile communication (GSM), General Packet Radio Service (CPRS), Code Division Multiple Access (CDMA), Wideband Code Division Multiple Access (WCDMA), Long Term Evolution (LTE), Email, Short Messaging Service (SMS), etc.

The storage 602 may be configured to store software program(s) and module(s), the processor 608 executes various applications and data processing by running the software program(s) and module(s) stored in the storage 602. The storage 602 may mainly include program storage area and data storage area, where the program storage area may store an operating system, an application program required for at least one function (e.g., a function of playing audio, a function of displaying image, etc.), etc.; the data storage area may store data (e.g., audio data, telephone book, etc.) created based on the usage of the terminal, etc. In addition, the storage 602 may include a high speed random access storage, a nonvolatile storage, e.g., at least one magnetic disk storage or flash disk, and any solid volatile storage. Correspondingly, the storage 602 may include a storage controller, which is configured to enable the processor 608 and the input unit 603 to access the storage 602.

The input unit 603 may be configured to receive an input number or input character information, and implement input of a signal, which is correlated to user configuration and function control, input through a keyboard, a mouse, an operating rod, an optical input device or a trackball. In an embodiment of the disclosure, the input unit 603 may include a touch-sensitive surface and any other input device. The touch-sensitive surface, also known as a touch screen or touch panel, may capture a touch operation on or nearby the surface (e.g., an operation on or near the touch-sensitive surface performed by a user with a finger, a stylus or any suitable object or accessory), and drive a corresponding connection means based on a preset program. Optionally, the touch-sensitive surface may include two components: a touch detection apparatus and a touch controller. The touch detection apparatus is configured to detect a touch position, detect the signal caused by the touch operation, and send the signal to the touch controller; the touch controller is configured to receive touch information from the touch detection apparatus, convert the touch information into coordinates of the touch position, send the coordinates to the processor 608, and receive and execute a command from the processor 608. In addition, the touch-sensitive surface may be implemented in many types, e.g., a resistance type, an infrared type, a Surface Acoustic Wave type, etc. Besides the touch-sensitive surface, the input unit 603 may include any other input device. Specifically, the any other input device includes but not limited to: any one of a physical keyboard, a function key (e.g., a key for controlling volume, an ON/OFF key, etc.), a trackball, a mouse and an operating rod or a combination thereof.

The display unit 604 is configured to display information input by the user, information provided to the user and various graphic user interfaces of the terminal, where those graphic user interfaces may consists of image, text, icon, video and any combination thereof. The display unit 604 may include a display panel, and optionally, the display panel may be in forms of a Liquid Crystal Display (LCD), an Organic Light-Emitting Diode (OLED), etc. Furthermore, the touch-sensitive surface may cover the display panel, after the touch operation is detected on or near the touch-sensitive surface, the touch information is sent to the processor 608 to determine the type of a touch event, then the processor 608 provides a corresponding visual output on the display panel based on the type of the touch event. Although in FIG. 6, the touch-sensitive surface and the display panel are implemented as two independent components to achieve input and output functions, the touch-sensitive surface and the display panel may be integrated together to achieve input and output functions according to some embodiments of the disclosure.

The terminal may further include at least one sensor 605, e.g., an optical sensor, a motion sensor and any other sensor. Specifically, the optical sensor may include an ambient light sensor and a proximity sensor, where the ambient light sensor may adjust the brightness of the display panel based on the intensity of ambient light, and the proximity sensor may turn off the display panel and/or a backlight when the terminal is moved near to an ear. As one kind of the motion sensor, a gravity acceleration sensor may detect values of accelerations on all directions (usually three-axis) and detect the value and direction of the gravity when remaining stationary. The gravity acceleration sensor may be applied in an application for recognizing posture of a mobile phone (for example, switching between landscape and portrait, relevant games, magnetometer pose calibration), a function related to vibration recognition (for example, a pedometer, knocking), etc.; in addition, other sensors, e.g., a gyroscope, a barometer, a hygrometer, a thermometer, an infrared sensor, etc. may be further provided in the terminal. the description of which is omitted herein.

The audio circuit 606, a loudspeaker and a microphone may provide an audio interface between the user and the terminal. The audio circuit 606 may transmit an electric signal converted from received audio data to the loudspeaker, and a voice signal is converted from the electric signal and is output by the loudspeaker; on the other hand, the microphone converts captured voice signal into an electric signal, the electric signal is received by the audio circuit 606 and converted into audio data, the audio data is output to the processor 608 to process and then sent to, for example, another device via the RF circuit 601. Alternatively, the audio data is output to the storage 602 for further processing. The audio circuit 606 may further include a headset jack through which an external earphone and the terminal may be connected.

WiFi is a technology for short distance wireless transmission. With the WiFi module 607, the terminal may insist the user in receiving and sending an email, browsing a web page, accessing a stream media, etc., and a wireless broadband Internet access is provided to the user. Although the WiFi module 607 is shown in FIG. 7, it should be understood that the WiFi module is not indispensable in the terminal and may be omitted without changing the essence of the disclosure.

The processor 608, as a control center of the terminal, is connected all components of the whole mobile phone via various interfaces and wires, monitors the whole mobile phone by running or executing the software program(s) and/or module(s) stored in the storage 602, invokes the data stored in the storage 602, executes various functions of the terminal and processes the data. Optionally, the processor 608 may include one or more processing cores; preferably, the processor 608 may be integrated with an application processor and a modern processor, where the application processor is mainly responsive of processing involved with the operating system, the user interface, the applications, etc. and the modem processor is mainly responsive of processing involved with the wireless communication. It may be understood that, the modem processor may not be integrated into the processor 608.

The terminal further includes the power source 609 (such as a battery) providing power to all the components. In an embodiment, the power source may be connected to the processor 608 logically through a power management system in order to implement functions of charging management, discharging management, power consumption management, etc. The power source 609 may further include one or more direct-current or alternating current power sources, a recharging system, a power failure detection circuit, a power adapter or inverter, a power status indicator, etc.

While not shown and described in the specification, the terminal may include, for example, a camera, a Bluetooth module, which will not be described here. According to an embodiment of the disclosure, the processor 608 in the terminal implements various functions by loading executable files corresponding to one or more processes of an application into the storage 602 and running the application stored in the storage 602 by the processor 608.

In at least one embodiment, the processor 608 can implement the functions that eyeball information of a user is acquired by a controlled terminal upon receiving an operation request of the user; an application request is sent to a control terminal, the application request carrying the eyeball information, for the control terminal to perform identity authentication according to the eyeball information; permission information returned by the control terminal is received after the identity authentication is passed; and the operation request is executed on the basis of the permission information.

In addition, the terminal can be a control terminal. In at least one embodiment, the processor 608 can implement the functions that an application request is received by a control terminal from a controlled terminal, the operation request carrying eyeball information; a preset eyeball information sample is acquired according to the application request; identity authentication is performed according to the eyeball information and the eyeball information sample; and if the identity authentication is passed, corresponding permission information is acquired based on the eyeball information and is returned to the controlled terminal; and if the identity authentication fails, the application request is rejected.

One can refer to the above embodiments about implementations of the respective devices, which will not be described here.

The terminal can achieve the beneficial effects of any one of the controlled devices and any one of the control devices; one can refer to the above embodiments for the details which will not be described here.

It should be understood by those skilled in the art that all or some of the steps in the methods according to the embodiments of the disclosure may be performed by a corresponding hardware instructed with a program. The program may be stored in a computer readable storage medium. The computer readable storage medium may include Read Only Storage (ROM), Random Access Storage (RAM), magnetic disk, Compact Disk, etc.

The terminal control method, device and system according to the embodiments of the disclosure are described in detail. The principle and implementation of the disclosure are illustrated with specific examples, which are set forth only for the purpose of better understanding of the method and core concept of the disclosure; changes to the specific embodiments and the application scope may be made by those skilled in the art based on the spirit of the disclosure, and the specification is not intended to limit the disclosure.

What is claimed is:

1. A terminal control method, comprising:
acquiring eyeball information of a user upon receiving an operation request of the user;
sending an application request to a control terminal, the application request carrying the eyeball information, for the control terminal to perform identity authentication according to the eyeball information;
receiving permission information returned by the control terminal after the identity authentication is passed; and
executing the operation request on the basis of the permission information.

2. The method of claim 1, further comprising, before sending the application request to the control terminal:
determining whether the user belongs to a preset user category according to the eyeball information, and
if the user belongs to a preset user category, send the application request to the control terminal,
otherwise, execute the operation request or reject the operation request according to a preset policy.

3. The method of claim 2, wherein determining whether the user belongs to a preset user category according to the eyeball information comprises:
acquiring a set of eyeball information samples corresponding to the preset user category,
determining whether there is, in the set of eyeball information samples, an eyeball information sample matching the eyeball information, and
if there is, determine that the user belongs to the preset user category;
otherwise, determine that the user does not belong to the preset user category.

4. The method of claim 1, wherein executing the operation request on the basis of the permission information comprises:
determining usage permission of the user according to the permission information; and
executing the operation request within a range of the usage permission.

5. The method of claim 4, wherein executing the operation request within the range of the usage permission comprises:
if the operation request is for starting the terminal, start and maintain an activation state of the terminal within a usage time range indicated by the usage permission; and
if the operation request is for accessing a terminal application, allow the user to access a corresponding function of the terminal application within a permission range indicated by the usage permission.

6. The method of claim 1, further comprising, before sending the application request to the control terminal:
acquiring eyeball information sample of the user, and
sending the eyeball information sample to the control terminal for the control terminal to store the eyeball information sample.

7. The method of claim 1, further comprising, before sending the application request to the control terminal:
acquiring and displaying a list of binding terminals,
receiving a selection instruction triggered by the user according to the list of binding terminals, and
determining a corresponding binding terminal as the control terminal from the list of binding terminals according to the selection instruction.

8. The method of claim 7, further comprising, before acquiring and displaying a list of binding terminals:
establish a binding relationship with the other terminals; and
create a list of binding terminals according to the binding relationship.

9. A terminal control method, comprising:
receiving an application request from a controlled terminal, the application request carrying eyeball information;
acquiring a preset eyeball information sample according to the application request;
performing identity authentication according to the eyeball information and the eyeball information sample;
if the identity authentication is passed, acquire corresponding permission information based on the eyeball information and return the permission information to the controlled terminal; and
if the identity authentication fails, reject the application request.

10. The method of claim 9, wherein acquiring corresponding permission information based on the eyeball information comprises:
determining user attribute based on the eyeball information; and
acquiring the corresponding permission information according to the user attribute.

11. The method of claim 9, further comprising, before acquiring a preset eyeball information sample according to the application request:
receiving input eyeball information sample of the user, or
receiving eyeball information sample of the user sent by the controlled terminal.

12. The method of claim 9, further comprising, before receiving an application request from a controlled terminal:
establishing a binding relationship with the controlled terminal.

13. A controlled device, comprising:
an acquiring unit, configured to acquire eyeball information of a user upon receiving an operation request of the user;
a sending unit, configured to send an application request to a control terminal, the application request carrying the eyeball information, for the control terminal to perform identity authentication according to the eyeball information;
a receiving unit, configured to receive permission information returned by the control terminal after the identity authentication is passed; and
an executing unit, configured to execute the operation request on the basis of the permission information.

14. The device of claim 13, further comprising a determining unit;
wherein the determining unit is configured to determine whether the user belongs to a preset user category according to the eyeball information;
the sending unit is configured to execute an operation of sending an application request to the control terminal, when the determining unit determines that the user belongs to the preset user category; and
the executing unit is configured to execute the operation request or reject the operation request according to a preset policy, when the determining unit determines that the user does not belong to the preset user category.

15. The device of claim 14, wherein the determining unit is configured to acquire a set of eyeball information samples corresponding to the preset user category, determine whether there is, in the set of eyeball information samples, an eyeball information sample matching the eyeball information, and
if there is, determine that the user belongs to the preset user category; otherwise, determine that the user does not belong to the preset user category.

16. The device of claim 13, wherein the executing unit is configured to determine usage permission of the user according to the permission information, and execute the operation request within a range of the usage permission.

17. The device of claim 13, wherein the acquiring unit is configured to acquire eyeball information of the user upon; and
the sending unit is configured to send the eyeball information sample to the control terminal for the control terminal to store the eyeball information sample.

18. The device of claim 13, further comprising a selecting unit;
wherein the acquiring unit is configured to acquire and display a list of binding terminals;
the receiving unit is configured to receive a selection instruction triggered by the user according to the list of binding terminals;
the selecting unit is configured to determine a corresponding binding terminal as the control terminal from the list of binding terminals according to the selection instruction.

19. The device of claim 18, further comprising a binding unit configured to establish a binding relationship with the other terminals, and to create a list of binding terminals according to the binding relationship.
